(19) United States
(12) Patent Application Publication
(10) Pub. No.: US 2009/0138491 A1
(43) Pub. Date: May 28, 2009

(54) Composite Tree Data Type

(76) Inventor: Sandeep Chowdhury, Bangalore (IN)

Correspondence Address: IBM CORPORATION, 3039 CORNWALLIS RD., DEPT. T81 / B503, PO BOX 12195, RESEARCH TRIANGLE PARK, NC, 27709, US

(21) Appl. No.: 11/946,532

(22) Filed: Nov. 28, 2007

(51) Int. Cl. G06F 17/30

(52) U.S. Cl. 707/100; 707/E17.044

(57) ABSTRACT

A method of representing tree-structure based data. The method comprises the steps of uncomposing tree-structure based data into a plurality of elements, the plurality of elements being of different types, storing the elements in a set, the set containing one or more of each element type, and storing one or more logical compositions with the set, each logical composition specifying at least one of each element type. Each logical composition is reducible to a combination of specific elements of each element type representing a specific instance of tree-structure based data.

### TECHNICAL FIELD

The present invention relates generally to data types, and in particular to a composite tree data type representing tree based documents and objects.

### BACKGROUND

Tree-structured based documents and objects are popular formats for storing and exchanging data. XML, for example, is a tree-structure based document widely used for exchanging data, and is also becoming a data type commonly stored in databases and queried by users. Service Data Objects (SDO) have also become popular as an object format for data transfer in the field of integration.

In the conventional way of representing tree-structure based documents and objects, the documents/objects are considered as a whole or a single unit. For example, XML content is perceived as a single entity, and the individual elements making up the XML content, such as the structure, labels, values and contents, are not looked upon or considered as separate entities. Such a representation encounters the disadvantages of:
(a) Unnecessary repetition: if a large number of documents have many elements in common, multiple copies are still required to contain them; and
(b) Loss of flexibility: if for example there is a need to modify the structure or content type of the document separately, the entire document needs to change.

United States Patent Application No. 20060031233A1 describes a universal format that is used to create a type representation of XMLType instances that are generated in various ways from various sources. An XMLType Type Tree is represented as a hierarchy of nodes, including a leaf item node, composite item node, operator node, and aggregate node, referred to herein as an XMLType Type Tree. An XMLType Type Tree serves as a digest of the type structure of XMLType, no matter the source of the XMLType instance or its manner of generation, and it creates one uniform abstraction of the type structure of XMLType for the data-typing analysis of XPath and XQuery during query compile time.

United States Patent Application No. 20020087596 describes a document written in a markup language, represented by a unique data structure. A virtual node tree describes the structure of the data types in the document. Each one of the nodes in the virtual node tree respectively corresponds to one of the data types in the document. A data array corresponding to each one of the nodes in the virtual node tree includes information identifying the relationship of the node to other nodes in the virtual node tree and a reference indicating the location of the data corresponding to the node. A set of software components obtains the data corresponding to the nodes using the references included in the data array.

United States Patent Application No. 20040028049 describes a method for communicating at least part of a structure of a document described by a hierarchical representation. The method identifies the hierarchical representation (eg. the tree structure) of the document. The identification is preferably performed using XML tags. The representation is then packetized into a plurality of data packets. At least one link is then created between a pair of the packets, the link acting to represent an interconnection between corresponding components (eg. structure and content) of the representation. The packets are then formed into a stream for communication. The links maintain the hierarchical representation within the packets.

In the above conventional methods, however, a document is not fully decomposed into structure, labels, values and content type such that each element is independent of the others (for example, where the structure is independent of labels). Hence, each of such elements (structure, label etc) cannot be re-used independently to construct other tree-structure based documents.

### SUMMARY

According to an aspect of the invention, a method of representing tree-structure based data comprises the steps of uncomposing tree-structure based data into a plurality of elements, the plurality of elements being of different types, storing the elements in a set, the set containing one or more of each element type, and storing one or more logical compositions with the set. Each logical composition specifying at least one of each element type. Each logical composition is reducible to a combination of specific elements of each element type representing a specific instance of tree-structure based data.

According to a further aspect of the invention, a method of composing tree-structure based data comprises the steps of receiving a data set, the data set comprising at least one logical composition and at least one element of each of a plurality of element types, selecting one element of each of the plurality of element types, in accordance with the at least one logical composition, and transforming the selected elements into a pre-determined tree-structure format.

According to a further aspect of the invention, a computer readable storage medium has stored therein computer executable code operable to, when executed, cause a computer to uncompose tree-structure based data into a plurality of elements, the plurality of elements being of different types, store the elements in a set, the set containing one or more of each element type, and store one or more logical compositions with the set. Each logical composition specifies at least one of each element type. Each logical composition is reducible to a combination of specific elements of each element type representing a specific instance of tree-structure based data.

According to a further aspect of the invention, a computer readable storage medium has stored therein computer executable code operable to, when executed, cause a computer to receive a data set, the data set comprising at least one logical composition and at least one element of each of a plurality of element types, select one element of each of the plurality of element types, in accordance with the at least one logical composition, and transform the selected elements into a pre-determined tree-structure format.

### BRIEF DESCRIPTION OF THE DRAWINGS

One or more embodiments of the present invention will now be described with reference to the drawings, in which:

FIG. 1 shows a tree structure of exemplary XML content.

FIG. 2 is a flow chart illustrating the process of converting a tree-based document to SLVC representation.

FIG. 3 is a flow chart illustrating the process of obtaining a Parent-Child Relationship Map.

FIG. 4 is a flow chart illustrating the process of obtaining a Parent-Child ID Map.

FIG. 5 shows a tree in second form.

FIG. 6 shows an exemplary object tree.

FIG. 7 is a flow chart illustrating the process of converting an object tree to SLVC representation.

FIG. 8 is a flow chart illustrating the process of converting an SLVC representation to a tree-based structure document.

FIG. 9 is a flow chart illustrating the process of obtaining a breadth-first to depth-first node mapping.

FIG. 10 is a flow chart illustrating the process of converting an SLVC representation to an object tree.

FIG. 11 is a schematic diagram of a computer system embodying the disclosed invention.

### DETAILED DESCRIPTION

Method, system and computer program products for representing tree-structure based documents and object trees are described. In the following detailed description, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

According to aspects of the disclosed invention, tree-based documents and object trees are deconstructed into four elements. The four elements, hereinafter referred to as SLVC, are:
Structure (S)
Labels (L)
Values (V)
Content Type or Object Type (C)

Each SLVC element is described with reference to Table 1, which shows an exemplary piece of XML content.

TABLE 1
school.xml

```
<School>
  <Student id=“studentId1”>
    <name>Peter</name>
    <standard>7</standard>
    <rank>15</rank>
    <aggregate>72</aggregate>
  </Student>
</School>
```

### Structure (S)

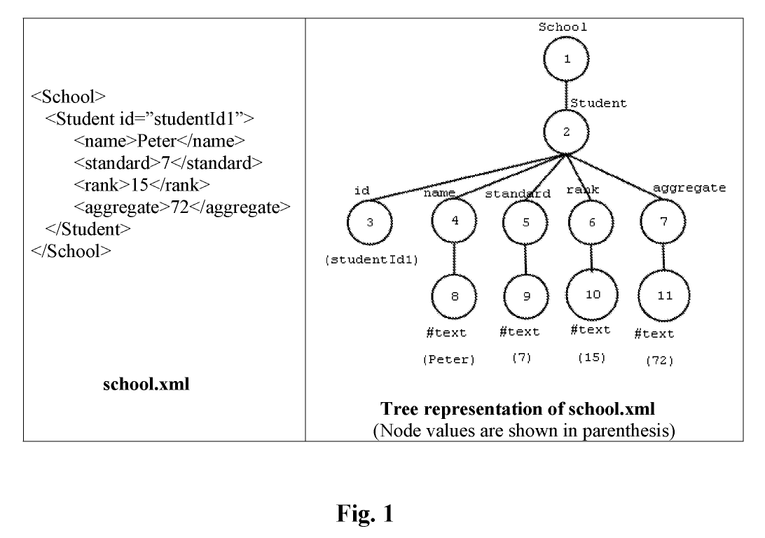

The tree structure of the content of table 1 is shown in FIG. 1. The tree structure can be uniquely represented by a structure code using an encoding method such as the prime number encoding method described in co-pending U.S. application Ser. No. ______ [IBM Docket No. IN920060038US1], and co-pending U.S. application Ser. No. ______ [IBM Docket No. IN920060037US1], which are incorporated herein in their entirety by reference. The structure code of the tree structure representing the XML content of table 1 is: 8270262

### Labels (L)

The labels of the XML content of table 1 are the names of the elements and attributes. The labels are listed below and ordered in the sequence of node IDs of the tree:
Labels={School, Student, id, name, standard, rank, aggregate, #text, #text, #text, #text}

### Values (V)

The values are the data values contained in the document. For the content of Table 1, the values are:
Values={studentId1, Peter, 7, 15, 72}

The values are associated with the leaf nodes of the tree.

### Content (C)

Content type is typically user specified. The content of Table 1 can be represented for example by “text/xml”.

It should be understood that while the content shown in Table 1 is XML content, any tree-structure based document or object can be deconstructed into the above four elements. Examples of other content types are “text/delimited”, “text/namevalue”, “text/fixedwidth”, and the like. Also object tree such as a Service Data Object (SDO), java object trees, and the like can also be deconstructed into SLVC elements, the only difference being that the content type is replaced by object type.

### Composite Tree Data Type

SLVC representation of tree-structure based documents and object trees to obtain a composite tree data type (CTDT) stores SLVC elements in an uncomposed form from which one or more documents/objects may be composed. Composition from SLVC elements can be performed on the fly. The uncomposed form is document/object neutral. A CTDT stores SLVC elements together with a set of compositions which map a combination of SLVC elements to a particular document/object.

A CTDT represents a tree-structure based document/object in an uncomposed format, such as a collection of SLVC values along with a collection of logical compositions. For example, a CTDT can be logically represented as shown in table 2:

TABLE 2
CTDT Construct

Collection of Logical Compositions (Compositions)
Collection of Structures (S)
Collection of Labels (L)
Collection of Values (V)
Collection of Content/Object Types (C)

The structures of CTDTs are the structure codes of the contents when represented as trees. An exemplary CTDT is shown in table 3:

TABLE 3
Exemplary CTDT

Compositions = {L₁V₁C₁*S, V₁C₁*S*L, S₂L₂V₁C₁}
S = {S₁, S₂}
L = {L₁, L₂}
V = {V₁, V₂}
C = {C₁, C₂}

The first composition L₁V₁C₁*S resolves to {S₁L₁V₁C₁, S₂L₁V₁C₁}.

The second composition V₁C₁*S*L resolves to {S₁L₁V₁C₁, S₁L₂V₁C₁, S₂L₁V₁C₁, S₂L₂V₁C₁}.

The third composition S₂L₂V₁C₁ resolves directly to S₂L₂V₁C₁.

A CTDT may be constructed from raw SLVC values, from a document or part thereof, or from an object tree, or from a combination of one or more of the above. For example, the Structure (S) may be obtained from a document, the Labels (L) from an object tree, and the Values (V) may be set directly. The SLVC format of a CTDT is independent of the format of the actual tree structure. The actual tree structure may be for example XML, SDO or java objects, but are represented uniformly in SLVC format in a CTDT.

A CTDT may comprise a collection of each SLVC. For example, a CTDT may have 5 structures, 10 sets of labels, 50 sets of values, and 7 content types. An actual document or object tree is composed by combining a number of these elements.

### CTDT Construction

### Document to SLVC Conversion

Construction of a CTDT from a tree-structure based document takes as input a tree structure-based document, the content-type of the document, and any meta-data required by a transformer to transform the document to a tree structure.

The input tree may be a tree with leaf attribute nodes, leaf text nodes, element nodes, or a combination of such nodes. A leaf attribute node is similar to an XML attribute. A leaf text node is similar to an XML #text node when it is parsed by a DOM parser. Nodes which are neither attribute nor #text nodes are element nodes. Element nodes containing values are the parents of #text nodes. Element nodes which contain values (which are parent of #text nodes) are termed value element nodes. The element nodes which do not contain values are termed object nodes. Hence, object nodes are those nodes which are neither attribute nodes, #text nodes, nor parent of #text nodes.

Referring to the tree of FIG. 1, node 3 is an attribute node, nodes 8 to 11 are text nodes (representing element values and henceforth represented as #text), and nodes 4 to 7 are value element nodes. Leaf attribute nodes have specific names, which may correspond, for example, to an attribute name in XML. In the exemplary XML content of FIG. 1, node 3 for example has the name “id”. A leaf text node has a general name “#text”, and identification of a particular leaf text node instead refers to the parent element node of the particular leaf text node. A tree structure containing #text nodes is referred to as a tree in second form. Conversely, a tree structure in which no #text nodes are present is referred to as a tree in first form. A CTDT represents the tree structure of documents in the second form. The second form has the advantage that it can uniquely represent the structure of tree-based documents and objects which have two types of nodes:attribute nodes and element nodes (an XML document is an example of this)

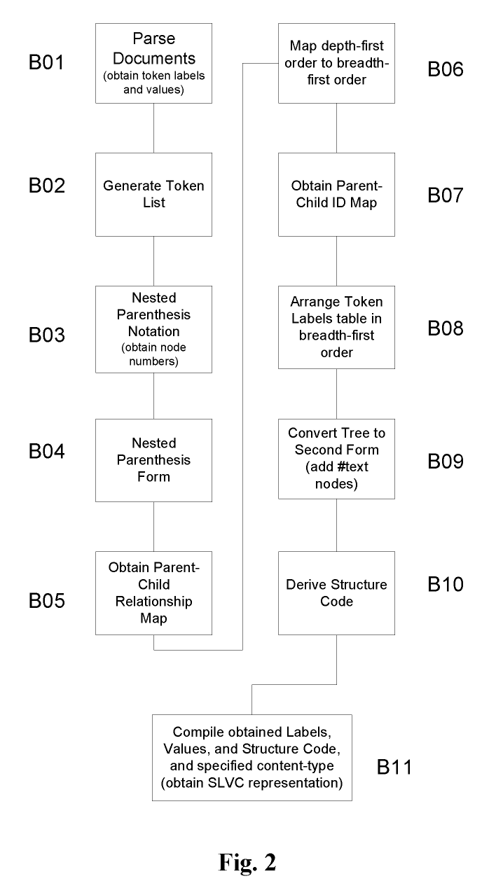

The conversion of a tree-structure based document to an SLVC representation is described with reference to the flow chart of FIG. 2.

At block B01, the document is parsed into tokens based on a predetermined separator. Depending on the document format, it may be necessary to first modify the document to ensure it can be properly parsed into tokens. Tokens parsed from a document indicate the type of node (object, attribute, or value element nodes) represented by the token. Object tokens contain both the start and the end of object indicators (for an XML document an XML fragment root node is an object token), and indicate whether the object token represents a start or end of an object. Node names are identifiable from object, attribute, or value element tokens, and node values should be determinable from attribute and value element tokens. The sequence of tokens, except of object tokens representing end object indicators, obtained from parsing a document follow a depth first sequence of tree traversal. At block B02, a token list is generated by the parser. The sequence of the tokens is the sequence in which the tokens are visited in the document.

Most popular tree-structure based documents may be parsed, or modified to be parsed, to obtain tokens as described above. Parsing for four different document formats is described:

### XML Document Format

Table 4 shows an exemplary XML document:

TABLE 4
Exemplary XML document

```
<Student id=“studentId1”>
  <Address>
    <houseNumber>17C</houseNumber>
    <street>Green Avenue</street>
    <postalCode>890015</postalCode>
  </Address>
  <ExamResult>
    <courseId>MA0012</courseId>
    <marks>75</marks>
  </ExamResult>
</Student>
```

An XML document may be parsed/tokenized based on angle brackets and by removing whitespaces. A resulting token table listing the token names obtained from parsing the XML document of Table 4 is:

| Token Names | Token Positions |
|---|---|
| s:Student | 1 |
| @id | 2 |
| s:Address | 3 |
| houseNumber | 4 |
| Street | 5 |
| postalCode | 6 |
| e:Address | 7 |
| s:ExamResult | 8 |
| courseId | 9 |
| Marks | 10 |
| e:ExamResult | 11 |
| e:Student | 12 |

An “s” prefix indicates the start of an object, whilst an “e” prefix represents the end of an object. An “@” prefix indicates an attribute node. The order of the tokens, with the exception of end objects indicated with the “e” prefix, is a depth-first traversal order of the XML document of Table 4.

The resulting table listing the token values is:

| Token Values | Token Positions |
|---|---|
| studentId1 | 2 |
| 17C | 4 |
| Green Avenue | 5 |
| 890015 | 6 |
| MA0012 | 9 |
| 75 | 10 |

### Name-Value Document Format

Table 5 shows an exemplary Name-Value document:

TABLE 5
Exemplary Name-Value document

```
StartBO:Student
  @id=studentId1
  StartBO:Address
    houseNumber=17C
    street=GreenAvenue
    postalCode=890015
  EndBO:Address
  StartBO:ExamResult
    courseId=MA0012
    marks=75
  EndBO:ExamResult
EndBO:Student
```

A Name-Value document may be parsed/tokenized based on newline/whitespace characters. A resulting token table listing the token names obtained from parsing the Name-Value document of Table 5 is:

| Token | Token |
|---|---|
| Names | Positions |
| s:Student | 1 |
| @id | 2 |
| s:Address | 3 |
| houseNumber | 4 |
| street | 5 |
| postalCode | 6 |
| e:Address | 7 |
| s:ExamResult | 8 |
| courseId | 9 |
| marks | 10 |
| e:ExamResult | 11 |
| e:Student | 12 |

The resulting table listing the token values is:

| Token Values | Token Positions |
|---|---|
| studentId1 | 2 |
| 17C | 4 |
| Green Avenue | 5 |
| 890015 | 6 |
| MA0012 | 9 |
| 75 | 10 |

### Delimited Document Format

Table 6 shows an exemplary delimited document:

TABLE 6
Exemplary Delimited document

StartBO:Student~@studentId1~StartBO:Address~17C~Green
Avenue~890015~EndBO:Address~
StartBO:ExamResult~MA0012~75~EndBO:ExamResult~EndBO:Student

A delimited document may be parsed/tokenized based on the delimiter, which in the case of the delimited document shown in Table 6, is the tilde ‘˜’. A resulting token table listing the token names obtained from parsing the delimited document of Table 6 is:

| Token Names | Token Positions |
|---|---|
| s:Student | 1 |
| @prop1 | 2 |
| s:Address | 3 |
| Prop1 | 4 |
| Prop2 | 5 |
| Prop3 | 6 |
| e:Address | 7 |
| s:ExamResult | 8 |
| Prop1 | 9 |
| Prop2 | 10 |
| e:ExamResult | 11 |
| e:Student | 12 |

where prop1, prop2 and prop3 are arbitrarily assigned token names.

The resulting table listing the token values is:

| Token Values | Token Positions |
|---|---|
| studentId1 | 2 |
| 17C | 4 |
| Green Avenue | 5 |
| 890015 | 6 |
| MA0012 | 9 |
| 75 | 10 |

Fixed Width Document Format (20 Characters Fixed Width with ‘#’ as Padding)

Table 7 shows an exemplary delimited document:

TABLE 7
Exemplary Fixed Width document

StartBO:Student#####@studentId1#########@studentId1#####StartBO:Address#####17C##
############### Green
Avenue########890015##############EndBO:Address#######StartBO:ExamResult##MA
0012##############
75##################EndBO:ExamResult########EndBO:Student#######

A fixed width document may be parsed/tokenized based on the fixed length tokens (in this case 20) and removing the padding characters. A resulting token table listing the token names obtained from parsing the fixed width document of Table 7 is:

| Token Names | Token Positions |
|---|---|
| s:Student | 1 |
| @prop1 | 2 |
| s:Address | 3 |
| prop1 | 4 |
| prop2 | 5 |
| prop3 | 6 |
| e:Address | 7 |
| s:ExamResult | 8 |
| prop1 | 9 |
| prop2 | 10 |
| e:ExamResult | 11 |
| e:Student | 12 |

where prop1, prop2 and prop3 are arbitrarily assigned token names.

The resulting table listing the token values is:

| Token Values | Token Positions |
|---|---|
| studentId1 | 2 |
| 17C | 4 |
| Green Avenue | 5 |
| 890015 | 6 |
| MA0012 | 9 |
| 75 | 10 |

Once documents are reduced to respective token lists/tables as shown above, the documents become content-type neutral. This uniformity enables application of computational techniques in a content-type neutral manner.

Returning to FIG. 2 at block B03, once a document has been parsed to obtain a token list, the tokens are represented using nested parenthesis notation. Representation of the tokens in nested parenthesis notation is described with reference to the exemplary token list/table of Table 8:

TABLE 8
Exemplary token table
Token Names

s:Student
@id
s:Address
houseNumber
street
postalCode
e:Address
s:ExamResult
courseId
marks
e:ExamResult
e:Student

The nested parenthesis syntax is arrived at from the tokens such that a start object is assigned a begin parenthesis “(”, an end object is assigned an end parenthesis “)”, and an attribute or value element is assigned a begin parenthesis followed by an end parenthesis “( )”. The parenthesis are assigned natural number values sequentially starting from 1 and an end parenthesis is assigned the negative of the begin parenthesis value.

Applying the above rules to the exemplary token table of Table 8, obtains a nested notation as follows:

| Token | Nested | |
|---|---|---|
| Names | Parenthesis | Values |
| s:Student | ( | 1 |
| @id | ( ) | 2 −2 |
| s:Address | ( | 3 |
| houseNumber | ( ) | 4 −4 |
| street | ( ) | 5 −5 |
| postalCode | ( ) | 6 −6 |
| e:Address | ) | −3 |
| s:ExamResult | ( | 7 |
| courseId | ( ) | 8 −8 |
| marks | ( ) | 9 −9 |
| e:ExamResult | ) | −7 |
| e:Student | ) | −1 |

Token labels may be derived from the nested notation. Token labels are obtained by removing the end of object tokens, and replacing the start of object indicators “s:” with “o:” to indicate that these tokens are objects. Further, the values in the above nested notation are used as node numbers. The token label table obtained in this manner is as follows:

| | Node |
|---|---|
| Token Labels | Numbers |
| s:Student | 1 |
| @id | 2 |
| o:Address | 3 |
| houseNumber | 4 |
| street | 5 |
| postalCode | 6 |
| o:ExamResult | 7 |
| courseId | 8 |
| marks | 9 |

The “o:” prefix indicates that a token is an object, and the “@” prefix indicates that a token is an attribute node.

Token values are retained in the same form in which they were initially obtained by the parser, with the exception that the token positions are replaced with node numbers of the same values. The token value table is hence defined as follows:

| Token Values | Node Numbers |
|---|---|
| studentId1 | 2 |
| 17C | 4 |
| Green Avenue | 5 |
| 890015 | 6 |
| MA0012 | 9 |
| 75 | 10 |

The above node numbers are consecutive in a depth-first order of tree traversal.

At block B04, a nested parenthesis form of the tree is obtained from the above nested notation. The nested parenthesis form is the sequence of values assigned to each parenthesis, namely:
1, 2, −2, 3, 4, −4, 5, −5, 6, −6, −3, 7, 8, −8, 9, −9, −7, −1

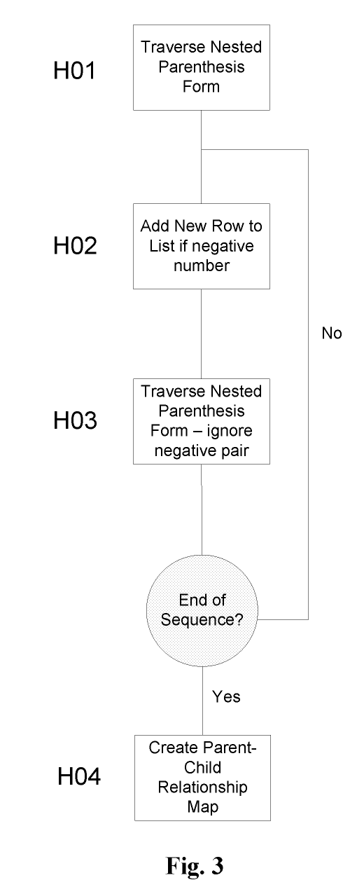

The nested parenthesis form represents the node IDs of the tree of FIG. 1 in depth-first tree traversal order. At step B05, a Parent-Child Relationship map is obtained from the nested parenthesis form. The process of obtaining the Parent-Child Relationship map is described with reference to the flow chart of FIG. 3.

At block H01, the sequence of numbers represented by the nested parenthesis form is traversed from left to right until a negative number is encountered. The sequence traversed is noted. For the above nested parenthesis form, the traversal is:
1, 2

At block H02, when a negative number is encountered (i.e. “−2”), the traversed sequence is copied as a new row of a growing list. The rows of the list at this stage are hence:
1, 2

At blocks H02 and H03, traversal is again performed from left to right but skipping the pair of numbers for which a negative number was encountered in block H02. That is, the sequence traversed is:
1, 3, 4

The numbers “2” and “−2” are skipped, as they are the pair of numbers corresponding to the negative number previously encountered (i.e. “−2). The above traversed sequence is noted, and added as a new row to the growing list:
1, 2
1, 3, 4

The process at block H03 is repeated until traversal of the sequence is completed. The resultant list is:

1, 2
1, 3, 4
1, 3, 5
1, 3, 6
1, 7, 8
1, 7, 9

At block H04, the Parent-Child Relationship map is created from the list. The list is read such that a first number to the left or a second number is a parent node of the second number. Hence, from the first row, node 1 is the parent of node 2. From the second row, node 1 is the parent of node 3, and node 3 is the parent of node 4. In this manner, the Parent-Child Relationship map obtained is:

Parent-Child Relationship map

| Parent Node Number | Child Node Numbers |
|---|---|
| 1 | 2, 3, 7 |
| 3 | 4, 5, 6 |
| 7 | 8, 9 |

At block B06, the Parent-Child Relationship map is used to map the depth-first ordered node numbers to breadth-first order. The child node numbers are obtained from the Parent-Child Relationship map:
2, 3, 7, 4, 5, 6, 8, 9

The first node is prefixed to the sequence of child nodes:
1, 2, 3, 7, 4, 5, 6, 8, 9

The above sequence represents the breadth-first order of nodes. Adding the above sequence of numbers as a row, adjacent to a row containing the depth-first order of nodes provides the depth-first to breadth-first mapping of nodes:

Depth-first to Breadth-first mapping

| | | | | | | | | | |
|---|---|---|---|---|---|---|---|---|---|
| Depth-First | 1 | 2 | 3 | 4 | 5 | 6 | 7 | 8 | 9 |
| Breadth-First | 1 | 2 | 3 | 5 | 6 | 7 | 4 | 8 | 9 |

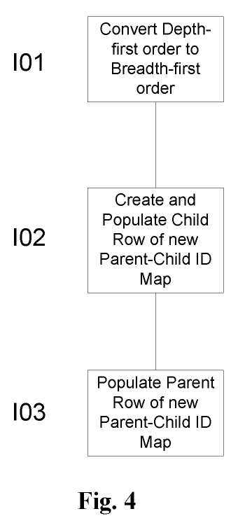

The depth-first to breadth-first mapping and the Parent-Child Relationship map are then used to obtain a Parent-Child ID Map at block B07. The process of obtaining the Parent-Child ID map is described with reference to the flow chart of FIG. 4.

At block I01, the depth-first ordered Parent-Child Relationship map is converted to a breadth-first orders using the Depth-first to Breadth-first mapping. The converted Parent-Child Relationship map is:

Parent-Child Relationship Map (Breadth-first)

| Parent Node Number | Child Node Numbers |
|---|---|
| 1 | 2, 3, 4 |
| 3 | 5, 6, 7 |
| 4 | 8, 9 |

At block I02, an empty Parent-Child ID Map is then populated by filing in the child row with a sequence of numbers beginning from 2:

Parent-Child ID Map

| Parent Node ID | | | | | | | | |
|---|---|---|---|---|---|---|---|---|
| Child Node ID | 2 | 3 | 4 | 5 | 6 | 7 | 8 | 9 |

At block I03, the parent row of the Parent-Child ID Map is populated with the node IDs of the corresponding parent node, referring to the breadth-first Parent-Child Relationship map derived at block I02. The resultant Parent-Child ID Map is:

Parent-Child ID Map

| | | | | | | | | |
|---|---|---|---|---|---|---|---|---|
| Parent Node ID | 1 | 1 | 1 | 3 | 3 | 3 | 4 | 4 |
| Child Node ID | 2 | 3 | 4 | 5 | 6 | 7 | 8 | 9 |

The node numbers of the Parent-Child ID map are hence breadth-first ordered node numbers.

The depth-first to breadth-first mapping is further used to arrange the Token Labels table and the Token Values table from a depth-first ordered sequence to a breadth-first ordered sequence (block B08). The resultant rearranged tables are:

Token Labels

| | Node |
|---|---|
| Token Labels | Numbers |
| o:Student | 1 |
| @id | 2 |
| o:Address | 3 |
| oExamResult | 4 |
| houseNumber | 5 |
| Street | 6 |
| postalCode | 7 |
| courseId | 8 |
| marks | 9 |

The o: prefix indicates that the token is an object, and the @ prefix indicates that the token is an attribute node

Token Values

| Token Values | Node Numbers |
|---|---|
| studentId1 | 2 |
| 17C | 5 |
| Green Avenue | 6 |
| 890015 | 7 |
| MA0012 | 8 |
| 75 | 9 |

From the rearranged Token Labels table and Token Values table, a token can be differentiated as being an object, value element, or attribute. The tokens in the Token Values table which are not attributes are value elements. Node 2 is an attribute token. The remaining nodes, nodes 5, 6, 7, 8, and 9, are value element nodes. The tree represented by the above tables is converted to its second form by adding #text nodes to the value element nodes (block B09).

Conversion of the tree to its second form involves determining the number of value element nodes from the token value list and the last node ID of the tree in first form. The number of value elements for the above tree is 5, and the last node ID is 9. A sequence of numbers equal to the number of value elements starting from the next number after the last node ID is then generated. A sequence of 5 numbers beginning from 10 is hence generated, namely 10, 11, 12, 13, and 14.

The Parent-Child ID Map is then modified by extending the number of columns by the number of numbers in the sequence:

Parent-Child Id Map (modified)

| | | | | | | | | | | | | | |
|---|---|---|---|---|---|---|---|---|---|---|---|---|---|
| Parent | 1 | 1 | 1 | 3 | 3 | 3 | 4 | 4 | — | — | — | — | — |
| Node Id | | | | | | | | | | | | | |
| Child | 2 | 3 | 4 | 5 | 6 | 7 | 8 | 9 | 10 | 11 | 12 | 13 | 14 |
| Node Id | | | | | | | | | | | | | |

The incomplete parent row of the modified Parent-Child ID Map is then filled in consecutively with the node numbers of the nodes which are value elements. Namely, 5, 6, 7, 8, and 9:

Parent-Child ID Map (modified)

| | | | | | | | | | | | | | |
|---|---|---|---|---|---|---|---|---|---|---|---|---|---|
| Parent | 1 | 1 | 1 | 3 | 3 | 3 | 4 | 4 | 5 | 6 | 7 | 8 | 9 |
| Node Id | | | | | | | | | | | | | |
| Child | 2 | 3 | 4 | 5 | 6 | 7 | 8 | 9 | 10 | 11 | 12 | 13 | 14 |
| Node Id | | | | | | | | | | | | | |

#text nodes are added to the Token Labels table corresponding to the newly added node numbers:

| | Node |
|---|---|
| Token Labels | Numbers |
| o:Student | 1 |
| @id | 2 |
| o:Address | 3 |
| o:ExamResult | 4 |
| houseNumber | 5 |
| Street | 6 |
| postalCode | 7 |
| courseId | 8 |
| marks | 9 |
| #text | 10 |
| #text | 11 |
| #text | 12 |
| #text | 13 |
| #text | 14 |

Then, referring to the Parent-Child ID Map, the Token Values table is modified such that the node numbers in the Token Values table are replaced with the newly generated node numbers of the #text node:

| Token Values | Node Numbers (old) | Node Numbers (new) |
|---|---|---|
| studentId1 | 2 | 2 |
| 17C | 5 | 10 |
| Green Avenue | 6 | 11 |
| 890015 | 7 | 12 |
| MA0012 | 8 | 13 |
| 75 | 9 | 14 |

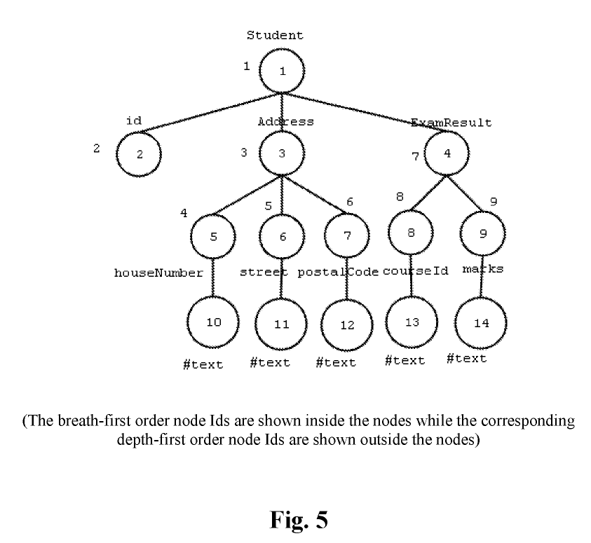

In this manner, the tree is converted to its second form, with #text nodes. The tree is shown in FIG. 5.

At block B10, the structure code is obtained from the Parent-Child ID Map according to the computation disclosed in U.S. application Ser. No. ______ [IBM Docket No. IN920060037US1], incorporated herein by reference. The structure code is 52055003000.

The structure code obtained from the above computation represents the tree structure uniquely. However to overcome certain special cases where two semantically different documents have the same tree structure, node Ids of special nodes (if any) need to be appended to the structure code obtained in the previous step. This will give the final structure code. These special cases are disclosed in U.S. application Ser. No. ______[IBM Docket No. IN920060037US1], with reference to XML documents, which are equally applicable for other tree based documents.

From the above, the structure code, labels, and values of the tree are obtained. Namely:
S=52055003000
L={Student, id, Address, ExamResult, houseNumber, street, postalCode, courseId, marks, #text, #text, #text, #text, #text}
V={studentId1, 17C, Green Avenue, 890015, MA0012, 75}.
C=The content is as specified by the user, and is text/xml for example.

At block B11, the above SLVC elements are compiled and the document is hence represented in SLVC representation.

### Object Tree to SLVC

Construction of a CTDT from an object tree takes as input the object, the object-type of the object, and configuration data for data transformation.

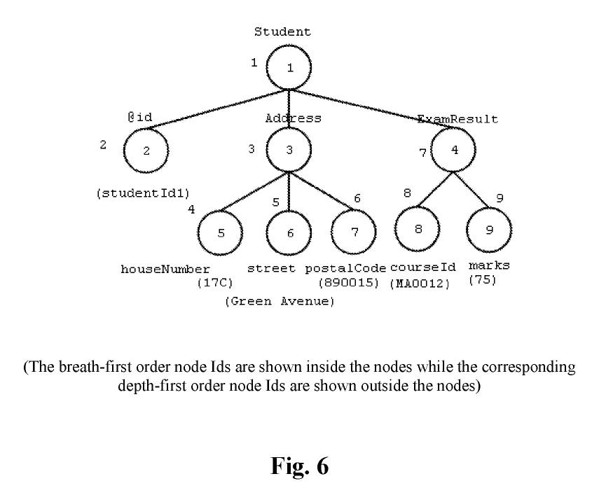

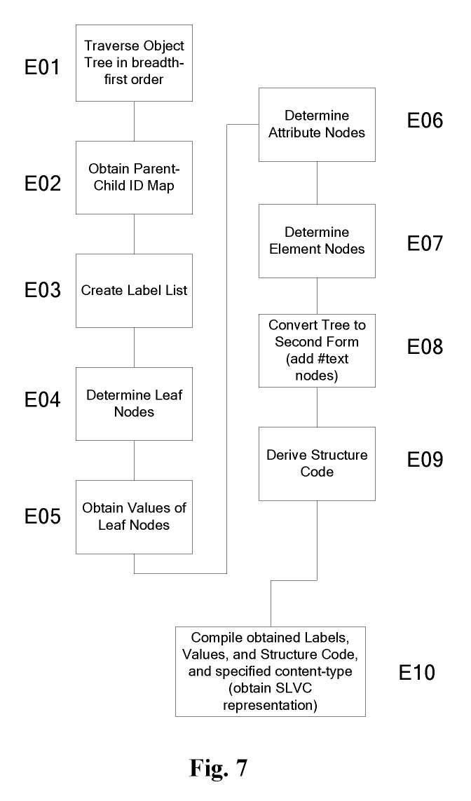

FIG. 6 shows an exemplary object tree. The object tree is in first form, meaning that no #text nodes are present. Attribute nodes in the object tree are identified with a “@” prefix before the attribute name. Conversion of the object tree to SLVC representation is described with reference to the flow chart of FIG. 7.

At block E01, the object tree is traversed in breadth-first order, and node IDs assigned to each node in this order. In FIG. 6, node IDs are shown inside each node. At block E02, a Parent-Child ID Map of the object tree is created. The Parent-Child ID Map can be created directly from the object tree as parent-child relationships between nodes are explicitly apparent from the object tree. The Parent-Child ID Map for the object tree of FIG. 6 is:

Parent-Child ID Map

| | | | | | | | | |
|---|---|---|---|---|---|---|---|---|
| Parent Node Id | 1 | 1 | 1 | 3 | 3 | 3 | 4 | 4 |
| Child Node Id | 2 | 3 | 4 | 5 | 6 | 7 | 8 | 9 |

At block E03, a label list in which the position of the nodes in the list correspond to the node ID of the object tree in breadth-first order is created. The label list is:
Labels={Student, #id, Address, ExamResult, houseNumber, street, postalCode, courseId, marks}

At block E04, the leaf nodes of the object tree are determined from the Parent-Child ID Map generated at block E02. The leaf nodes are obtained from the Parent-Child ID Map as follows. The leaf nodes are those nodes which are present in the child row of the Parent-Child Id Map and not present in the parent row of the Parent-Child Id Map.
Leaf nodes={2, 5, 6, 7, 8, 9}

At block E05, the values of the leaf nodes are obtained from the tree:
Values={studentId1, 17C, Green Avenue, 890015, MA0012, 75}

At block E06, the attribute nodes of the tree are determined from the label list obtained at block E03. As previously described, the attribute nodes are the nodes whose labels bear a predetermined label. In the present example, nodes prefixed with “@” are attribute nodes. A list of attribute nodes is:
Attribute Nodes={2}

At block E07, the value element nodes of the tree are determined from the leaf node list. The value element nodes are the nodes of the leaf node list which are not attribute nodes. The list of value element nodes is hence:
Value Element Nodes={5, 6, 7, 8, 9}

It should be noted that for a tree in second form, the value element nodes are the parent nodes of #text nodes.

The tree is converted to second from at block E08 by adding #text nodes, in the manner as described previously with reference to conversion of a document to SLVC representation. The Parent-Child ID Map of the object tree after conversion to second form is:

Parent-Child ID Map (second form)

| | | | | | | | | | | | | | |
|---|---|---|---|---|---|---|---|---|---|---|---|---|---|
| Parent | 1 | 1 | 1 | 3 | 3 | 3 | 4 | 4 | 5 | 6 | 7 | 8 | 9 |
| Node Id | | | | | | | | | | | | | |
| Child | 2 | 3 | 4 | 5 | 6 | 7 | 8 | 9 | 10 | 11 | 12 | 13 | 14 |
| Node Id | | | | | | | | | | | | | |

And the labels list is:
Labels (second form)={Student, #id, Address, ExamResult, houseNumber, street, postalCode, courseId, marks, #text, #text, #text, #text, #text}

It should be understood that if the input tree was already in second form, the conversion performed at block E08 may be skipped.

At block E09, the structure code is determined from the Parent-Child ID Map according to the computation as described previously with reference to conversion of a document to SLVC representation. The structure code is: 52055003000.

In the above manner, all SLVC elements are determined. Specifically:
S=52055003000
L={Student, #id, Address, ExamResult, houseNumber, street, postalCode, courseId, marks, #text, #text, #text, #text}
V={studentId1, 17C, Green Avenue, 890015, MA0012, 75}
   C=commonj.sdo.DataObject (specified by the user)

At block E10, the SLVC elements are compiled and the object tree is hence represented in SLVC representation.

Conversion from CTDT

### SLVC to Document Conversion

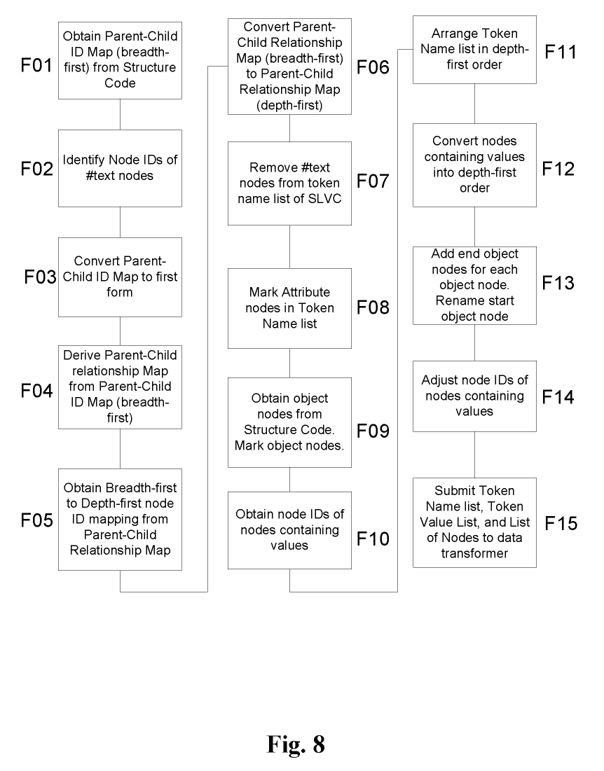

Conversion of a CTDT from an SLVC representation to a tree-structure based document takes as input the SLVC representation, and any configuration data that may be required for data transformation. Conversion of a CTDT from an SLVC representation to a tree-structure based document is described with reference to the exemplary SLVC representation of table 7 and the flow chart of FIG. 8.

TABLE 7
Exemplary SLVC data

| | |
|---|---|
| S = | 52055003000 |
| L = | {Student, id, Address, ExamResult, houseNumber, street, |
| | PostalCode, courseID, marks, #text, #text, #text, #text, |
| | #text,} |
| V = | {studentID1, 17C, Green Avenue, 890015, MA0012, 75} |
| C = | text/xml (specified by user) |

At block F01, a Parent-Child ID Map is obtained from the structure code of the SLVC representation. The Parent-Child ID Map is obtained from the structure code using the technique described in co-pending U.S. application Ser. No. ______[IBM Docket No. IN920060037US1].

The Parent-Child ID Map is:

Parent-Child ID Map

| | | | | | | | | | | | | | |
|---|---|---|---|---|---|---|---|---|---|---|---|---|---|
| Parent | 1 | 1 | 1 | 3 | 3 | 3 | 4 | 4 | 5 | 6 | 7 | 8 | 9 |
| Node Id | | | | | | | | | | | | | |
| Child | 2 | 3 | 4 | 5 | 6 | 7 | 8 | 9 | 10 | 11 | 12 | 13 | 14 |
| Node Id | | | | | | | | | | | | | |

where the node IDs are breadth-first ordered.

In cases where the structure code has special nodes appended, as described in co-pending U.S. application Ser. No. ______ [IBM Docket No. IN920060038US1], the above computation applies to the first part of the structure code which is obtained by separating it from the appended special nodes.

At block F02, from the label list L, the node IDs of the #text nodes are identified. The node IDs are:
#text node IDs={10, 11, 12, 13, 14}

At block F03, the Parent-Child ID Map, which is in the second form, is converted to the first form by removing the #text nodes from the map and transforming the Parent-Child ID Map. The columns of the Parent-Child ID Map containing the #text node IDs are removed. The Parent-Child ID Map in first form is:

Parent-Child ID Map (first form)

| | | | | | | | | |
|---|---|---|---|---|---|---|---|---|
| Parent Node Id | 1 | 1 | 1 | 3 | 3 | 3 | 4 | 4 |
| Child Node Id | 2 | 3 | 4 | 5 | 6 | 7 | 8 | 9 |

At block F04, a Parent-Child Relationship Map is derived from the Parent-Child ID Map (first form). The Parent-Child ID Map gives the mapping between parent nodes and child nodes. When a parent node has multiple child nodes, the relationships are repeated. If the Parent-Child mapping are not repeated, and each parent node is associated with all its children, the Parent-Child Relationship Map is obtained. The Parent-Child Relationship Map derived in this manner is in breath-first order and is:

Parent-Child Relationship Map (breadth-first)

| Parent Node Id | Child Node Ids |
|---|---|
| 1 | 2, 3, 4 |
| 3 | 5, 6, 7 |
| 4 | 8, 9 |

At block F05, a breadth-first to depth-first node mapping is obtained from the Parent-Child ID Map (first form).

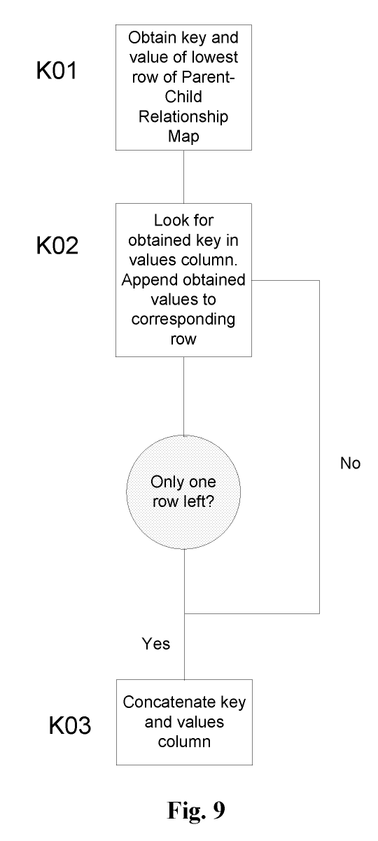

The process of obtaining the breadth-first to depth-first node mapping is described with reference to the flow chart of FIG. 9, and the Parent-Child Relationship map (breadth-first).

Parent-Child Relationship Map (breadth-first)

| Parent Node Number | Child Node Numbers |
|---|---|
| 1 | 2, 3, 4 |
| 3 | 5, 6, 7 |
| 4 | 8, 9 |

At block K01, the key and value of the lower most row of the Parent-Child Relationship map (breadth-first) is obtained:
4: 8, 9

At block K02, the key obtained at block K01 is searched for in the value column of the Parent-Child Relationship map (breadth-first). The values obtained at block K01 are appended to the values of the row containing the key in its value column, and the lower most row is deleted.

Parent-Child Relationship map (modified)

| Parent Node Number | Child Node Numbers |
|---|---|
| 1 | 2, 3, 4, 8, 9 |
| 3 | 5, 6, 7 |

Block K02 is repeated until the table has only one row:

Parent-Child Relationship map (modified)

| Parent Node Number | Child Node Numbers |
|---|---|
| 1 | 2, 3, 5, 6, 7, 4, 8, 9 |

At block K03, the key and values of the modified Parent-Child Relationship map are concatenated to form a row:

1, 2, 3, 5, 6, 7, 4, 8, 9

The breadth-first to depth-first map is created from the above row, and a new row containing a sequence of numbers representing the depth-first order of nodes:

Breadth-First to Depth-First node mapping

| | |
|---|---|
| Breadth-First | 1, 2, 3, 5, 6, 7, 4, 8, 9 |
| Depth-First | 1, 2, 3, 4, 5, 6, 7, 8, 9 |

The above map may be sorted by Breadth-first order to facilitate easier reference:

Breadth-first to Depth-first node mapping

| | | | | | | | | | |
|---|---|---|---|---|---|---|---|---|---|
| Breadth-First | 1 | 2 | 3 | 4 | 5 | 6 | 7 | 8 | 9 |
| Depth-First | 1 | 2 | 3 | 7 | 4 | 5 | 6 | 8 | 9 |

At block F06, the Parent-Child Relationship Map in breadth-first order is transformed to depth-first order using the breadth-first to depth-first node mapping. The transformed Parent-Child Relationship Map in depth-first order is:

Parent-Child Relationship Map (depth-first)

| Parent Node Id | Child Node Ids |
|---|---|
| 1 | 2, 3, 7 |
| 3 | 4, 5, 6 |
| 7 | 8, 9 |

At block F07, the labels from the SLVC representation are separated into a Token Name list without the #text nodes. The Token Name list is:
Token Name list (breadth-first)={Student, ID, Address, ExamResult, houseNumber, street, postalCode, courseID, marks}

The position of the nodes corresponds to the node IDs of the tree.

At block F08, the token name list is modified to mark the attribute nodes with a predetermined identifier. The attribute nodes can be identified by identifying all leaf nodes which are not #text nodes. From the Parent-Child Id Map (second form) the leaf nodes are those nodes which are present in the child row but not in the parent row of the Parent-Child ID map. Therefore the leaf nodes are:
Leaf nodes={2, 10, 11, 12, 13, 14}

Any leaf node whose parent has a grandchild is an attribute node if it is not a special node. Since node Ids of special nodes are appended with the structure code, it is known which nodes are special nodes. Any leaf node which is not an attribute node is a #text node.

Special nodes are described in further detail in co-pending U.S. application Ser. No. ______ [IBM Docket No. IN920060038US1] with reference to XML data, but is equally applicable to other tree-based data. Knowing the parent-child hierarchy of node Ids from the Parent-Child ID map (second form), the #text nodes are determined as described above. The #text nodes are hence:
#text nodes={10, 11, 12,13, 14}

The attribute node is hence:
Attribute nodes={2}

In the present example, the attribute nodes in the Token Name list are marked with an ‘@’ prefix. The Token list is hence:
Token Name list (breadth-first)={Student, @id, Address, ExamResult, houseNumber, street, postalCode, courseID, marks}

At block F09, the object nodes are identified from the structure code, and identified in the Token Name list. The object nodes are identified as nodes which are neither attribute nodes, value element nodes, nor #text nodes. The #text nodes are already known. The value element nodes are the parent nodes of the #text nodes and are hence:
Value Element nodes={5, 6, 7, 8, 9}

The object nodes are hence:
Object nodes={1, 3, 4}

In the present example, the object nodes are marked with an “o:” prefix in the Token Names list. The Token list is hence:

Token Name list (breadth-first)={o:Student, @id, o:Address, o:ExamResult, houseNumber, street, postalCode, courseID, marks}

At block, F10 the node IDs of the nodes containing values (breadth-first order) are obtained. This is a combination of attribute nodes and value element nodes. The node IDs sorted in ascending order are:
Nodes containing values (breadth-first)={2, 5, 6, 7, 8, 9}

At block F11, the Token Name list is arranged in depth-first order using the Breadth-first to Depth-first mapping previously determined.
Token Name list (depth-first)={o:Student, @id, o:Address, houseNumber, street, postalCode, o:ExamResult, courseID, marks}

At block F12, the list of nodes containing values obtained at block F10 is transformed from a listing of breadth-first IDs to a listing of depth-first IDs using the breadth-first to depth-first mapping:
Nodes containing values (depth-first)={2, 4, 5, 6, 8, 9}

At block F13, the child nodes for each object node in the Token Name list (depth-first) are identified using the depth-first Parent-Child Relationship map obtained at block F06. An end object indicator is added to the Token Name list after the last child node of each object node. Object prefixes “o:” are replaced with an object start prefix “s:”. For example, from the Parent-Child Relationship map (depth-first), it is determined that the child nodes of the “Address” node (having node ID 3), are nodes 4, 5 and 6. The last child node of the object node “Address” is therefore node 6, which is 3 nodes away from the object node “o:Address”. A new entry “e:Address” is therefore added to the Token Name list 3 entries from “o:Address”, and “o:Address” is renamed “s:Address”. This modification is performed for each object name in the Token Name list.

The Token Name list after this process is:
Token Name list (depth-first)={s:Student, #id, s:Address, houseNumber, street, postaIC ode, e:Address, s:ExamResult, courseID, marks, e:ExamResult, e:Student}

At block F14, the node IDs in the list of nodes containing values (depth-first) is adjusted by adding to each node ID in the list, the number of end object nodes between the first node and each node, respectively. Referring, for example, to the node having node ID 8 in the list of nodes containing values (depth-first), the number of end object nodes between this node and the first node of the Token Name list is determined:

The node having node ID 8 in the list of nodes containing values (depth-first) is “courseID”.

The nodes between first node and the “courseID” node are:
s:Student
@id
s:Address
houseNumber
street
postalCode
e:Address (*)
s:ExamResult

The number of end object nodes is 1, being the “e:Address” node. Node ID 8 in the list of nodes containing values (depth-first) is hence adjusted by adding 1, giving it an adjusted Node ID of 9. Performing this adjustment to each node in the list of node containing values (depth-first) yields an adjusted list of nodes:
Nodes containing values (depth-first, adjusted)={2, 4, 5, 6, 9, 10}

At block F15, the Token Name list, Token Value list, and list of nodes containing values is submitted to a data transformer corresponding to a data transformer appropriate for the content type specified by the SLVC representation. The data transformer hence receives as input:
Token Name list (depth-first)={s:Student, @id, s:Address, houseNumber, street, postalCode, e:Address, s:ExamResult, courseId, marks, e:ExamResult, e:Student}
Token Value list={studentId1, 17C, Green Avenue, 890015, MA0012, 75}
Nodes containing values (depth-first, adjusted)={2, 4, 5, 6, 9, 10}

From the above information, the data transformer reproduces a document (for example, an XML document).

### SLVC to Object Conversion

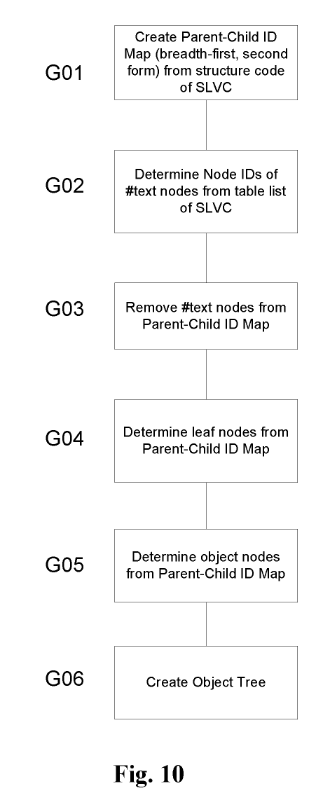

Conversion of a CTDT from an SLVC representation to an object tree takes as input the SLVC representation, and any configuration data that may be required for data transformation. Conversion of a CTDT from an SLVC representation to an object tree is described with reference to the exemplary SLVC representation of table 9. and the flow chart of FIG. 10.

TABLE 7
Exemplary SLVC data

| | |
|---|---|
| S = | 52055003000 |
| L = | {Student, id, Address, ExamResult, houseNumber, street, |
| | PostalCode, courseID, marks, #text, #text, #text, #text, |
| | #text,} |
| V = | {studentID1, 17C, Green Avenue, 890015, MA0012, 75} |
| C = | commonj.sdo.DataObject (specified by user) |

At block G01, a Parent-Child ID map is created from the structure code of the SLVC representation, as described in the above co-pending U.S. application Ser. No. ______ [IBM Docket No. IN920060037US1]. The Parent-Child ID map is in second form, including #text nodes:

Parent-Child ID Map (breadth-first, second form)

| | | | | | | | | | | | | | |
|---|---|---|---|---|---|---|---|---|---|---|---|---|---|
| Parent | 1 | 1 | 1 | 3 | 3 | 3 | 4 | 4 | 5 | 6 | 7 | 8 | 9 |
| Node Id | | | | | | | | | | | | | |
| Child | 2 | 3 | 4 | 5 | 6 | 7 | 8 | 9 | 10 | 11 | 12 | 13 | 14 |
| Node Id | | | | | | | | | | | | | |

At block G02, the node IDs of the #text nodes are determined from the labels list of the SLVC representation. The Node IDs are obtained from the position of the #text nodes in the labels list: The Node IDs correspond to the position indices of the #text nodes in the labels list if the position index of the first element is taken as 1.
#text nodes={10, 11 12, 13, 14}

At block G03, the #text nodes are removed from the Parent-Child ID map if the object tree to be output does not require #text nodes to be retained. Otherwise, the conversion skips to block G04:

Parent-Child ID Map (#text nodes removed)

| | | | | | | | | |
|---|---|---|---|---|---|---|---|---|
| Parent Node Id | 1 | 1 | 1 | 3 | 3 | 3 | 4 | 4 |
| Child Node Id | 2 | 3 | 4 | 5 | 6 | 7 | 8 | 9 |

At block G04, the leaf nodes are determined from the Parent-Child ID map:
Leaf nodes={2, 5, 6, 7, 8, 9}

At block G05, the object nodes are determined from the Parent-Child ID map. The object nodes here are the non-leaf nodes since the tree is in first-form:
Object nodes={1, 3, 4}

At block G06, an object tree of a type specified by the object type in the SLVC representation is created. The object tree has node names as obtained from the labels list, value nodes having values corresponding to the leaf nodes, and parent-child relationship between nodes as given by the Parent-Child ID Map.

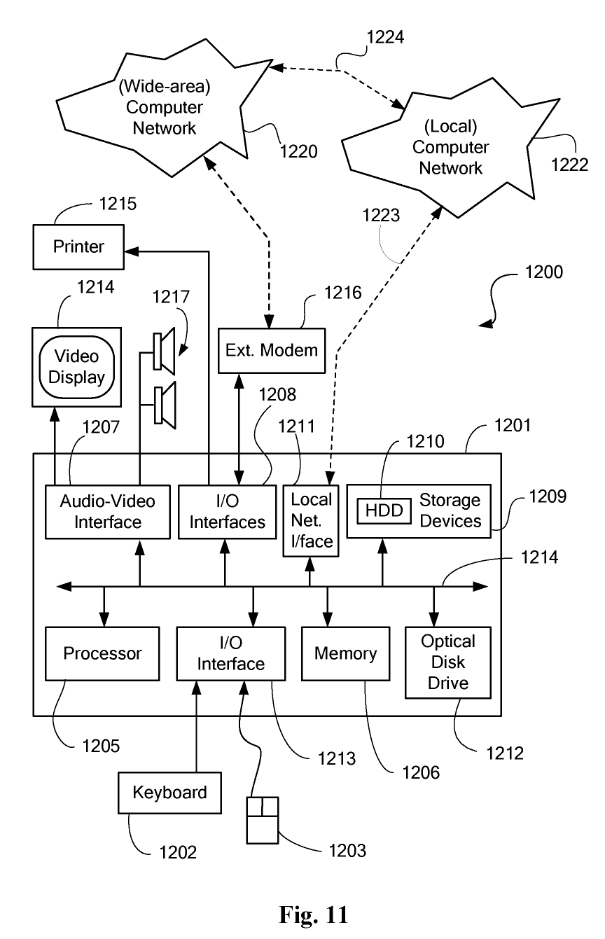

The above method of converting tree-structure based documents and object trees to/from SLVC representation, may be implemented using a computer system 1200, such as that shown in FIG. 11 wherein the processes of FIGS. 3 to 5 and 8 to 10 may be implemented as software, such as one or more application programs executable within the computer system 1200. In particular, the steps of the described methods/processes are effected by instructions in the software that are carried out within the computer system 1200. The instructions may be formed as one or more code modules, each for performing one or more particular tasks. The software may also be divided into two separate parts, in which a first part and the corresponding code modules performs the conversion methods and a second part and the corresponding code modules manage a user interface between the first part and the user.

The software may be stored in a computer readable medium, including the storage devices described below, for example. The software is loaded into the computer system 1200 from the computer readable medium, and then executed by the computer system 1200. A computer readable medium having such software or computer program recorded on it is a computer program product. The use of the computer program product in the computer system 1200 preferably effects an advantageous apparatus for converting tree-structure based documents and object trees to an SLVC representation, and vice versa.

As seen in FIG. 11, the computer system 1200 is formed by a computer module 1201, input devices such as a keyboard 1202 and a mouse pointer device 1203, and output devices including a printer 1215, a display device 1214 and loudspeakers 1217. An external Modulator-Demodulator (Modem) transceiver device 1216 may be used by the computer module 1201 for communicating to and from a communications network 1220 via a connection 1221. The network 1220 may be a wide-area network (WAN), such as the Internet or a private WAN. Where the connection 1221 is a telephone line, the modem 1216 may be a traditional dial-up modem. Alternatively, where the connection 1221 is a high capacity (eg: cable) connection, the modem 1216 may be a broadband modem. A wireless modem may also be used for wireless connection to the network 1220.

The computer module 1201 typically includes at least one processor unit 1205, and a memory unit 1206 for example formed from semiconductor random access memory (RAM) and read only memory (ROM). The module 1201 also includes an number of input/output (I/O) interfaces including an audio-video interface 1207 that couples to the video display 1214 and loudspeakers 1217, an I/O interface 1213 for the keyboard 1202 and mouse 1203 and optionally a joystick (not illustrated), and an interface 1208 for the external modem 1216 and printer 1215. In some implementations, the modem 1216 may be incorporated within the computer module 1201, for example within the interface 1208. The computer module 1201 also has a local network interface 1211 which, via a connection 1223, permits coupling of the computer system 1200 to a local computer network 1222, known as a Local Area Network (LAN). As also illustrated, the local network 1222 may also couple to the wide network 1220 via a connection 1224, which would typically include a so-called firewall device or similar functionality. The interface 1211 may be formed by an Ethernet™ circuit card, a wireless Bluetooth™ or an IEEE 802.11 wireless arrangement.

The interfaces 1208 and 1213 may afford both serial and parallel connectivity, the former typically being implemented according to the Universal Serial Bus (USB) standards and having corresponding USB connectors (not illustrated). Storage devices 1209 are provided and typically include a hard disk drive (HDD) 1210. Other devices such as a floppy disk drive and a magnetic tape drive (not illustrated) may also be used. An optical disk drive 1212 is typically provided to act as a non-volatile source of data. Portable memory devices, such optical disks (eg: CD-ROM, DVD), USB-RAM, and floppy disks for example may then be used as appropriate sources of data to the system 1200.

The components 1205, to 1213 of the computer module 1201 typically communicate via an interconnected bus 1204 and in a manner which results in a conventional mode of operation of the computer system 1200 known to those in the relevant art. Examples of computers on which the described arrangements can be practised include IBM-PC and compatibles, Sun Sparcstations, Apple Mac™ or alike computer systems evolved therefrom.

Typically, the application programs discussed above are resident on the hard disk drive 1210 and read and controlled in execution by the processor 1205. Intermediate storage of such programs and any data fetched from the networks 1220 and 1222 may be accomplished using the semiconductor memory 1206, possibly in concert with the hard disk drive 1210. In some instances, the application programs may be supplied to the user encoded on one or more CD-ROM and read via the corresponding drive 1212, or alternatively may be read by the user from the networks 1220 or 1222. Still further, the software can also be loaded into the computer system 1200 from other computer readable media. Computer readable media refers to any storage medium that participates in providing instructions and/or data to the computer system 1200 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1201. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display 1214. Through manipulation of the keyboard 1202 and the mouse 1203, a user of the computer system 1200 and the application may manipulate the interface to provide controlling commands and/or input to the applications associated with the GUI(s).

The method of converting tree-structure based documents and object trees to/from SLVC representation may alternatively be implemented in dedicated hardware such as one or more integrated circuits. Such dedicated hardware may include graphic processors, digital signal processors, or one or more microprocessors and associated memories.

The foregoing describes only some embodiments of the present invention, and modifications and/or changes can be made thereto without departing from the scope and spirit of the invention, the embodiments being illustrative and not restrictive.

1. A method of representing tree-structure based data, the method comprising the steps of:
uncomposing tree-structure based data into a plurality of elements, the plurality of elements being of different types;
storing the elements in a set, the set containing one or more of each element type; and
storing one or more logical compositions with the set, each logical composition specifying at least one of each element type,
wherein each logical composition is reducible to a combination of specific elements of each element type representing a specific instance of tree-structure based data.

2. The method according to claim 1, wherein tree-structure based data is uncomposed into a structure element, a labels element, a values element, and a content-type element.

3. The method according to claim 2, wherein the structure element is a structure code uniquely identifying the structure of the tree-structure based data.

4. The method according to claim 2, wherein the labels element is a list of labels in the tree-structure based data.

5. The method according to claim 2, wherein the values element is a list of values contained in the tree-structure based data.

6. The method according to claim 2, wherein the content-type element is an identifier identifying the content-type of the tree-structure based document.

7. The method according to claim 1, wherein one or more of the at least one logical composition specifies a specific one of each element stored in the set.

8. The method according to claim 1, wherein one or more of the at least one logical composition specifies a generic one of each element stored in the set.

9. The method according to claim 1, wherein one or more of the at least one logical composition specifies a combination of specific and generic elements stored in the set.

10. The method according to claim 1, wherein the plurality of elements uncomposed from the tree-structure based data are stored in the set in a format independent of a format of the tree-structure based data.

11. The method according to claim 1, wherein the elements are stored in an existing set comprising elements uncomposed from other tree-structure based data.

12. A method of composing tree-structure based data, the method comprising the steps of:
receiving a data set, the data set comprising at least one logical composition and at least one element of each of a plurality of element types;
selecting one element of each of the plurality of element types, in accordance with the at least one logical composition; and
transforming the selected elements into a pre-determined tree-structure format.

13. The method according to claim 12, wherein the step of selecting selects one elements from each of a structure element type, a labels element type, a values element type, and a content-type element type.

14. The method according to claim 13, wherein the structure element type is a structure code uniquely identifying a tree structure.

15. The method according to claim 13, wherein the labels element type is a list of labels.

16. The method according to claim 13, wherein the values element type is a list of values.

17. The method according to claim 13, wherein the content-type element type is an identifier identifying a content-type of a tree-structure.

18. A computer readable storage medium having stored therein computer executable code operable to, when executed, cause a computer to perform the steps of:
uncomposing tree-structure based data into a plurality of elements, the plurality of elements being of different types;
storing the elements in a set, the set containing one or more of each element type; and
storing one or more logical compositions with the set, each logical composition specifying at least one of each element type,
wherein each logical composition is reducible to a combination of specific elements of each element type representing a specific instance of tree-structure based data.

19. The computer readable storage medium according to claim 18, wherein tree-structure based data is uncomposed into a structure element, a labels element, a values element, and a content-type element.

20. The computer readable storage medium according to claim 19, wherein the structure element is a structure code uniquely identifying the structure of the tree-structure based data.

21-34. (canceled)
